(19) United States
(12) Patent Application Publication
(10) Pub. No.: US 2019/0183707 A1
(43) Pub. Date: Jun. 20, 2019

(54) DEVICE FOR ASSISTED OMNIDIRECTIONAL MOVEMENT OF HOSPITAL BEDS AND OTHER OMNIDIRECTIONALLY MOBILE LOADS

(71) Applicants: POLITECNICO DI MILANO, Milano (Ml) (IT); UNIVERSITA' DEGLI STUDI DI MILANO-BICOCCA, Milano (Ml) (IT); INFO SOLUTION S.P.A., Vimodrone (MI) (IT)

(72) Inventors: Giulio Angelo Eugenio Fontana, Milano (MI) (IT); Matteo Matteucci, Saronno (VA) (IT); Domenico Giorgio Sorrenti, Milano (MI) (IT); Giovanni De Salvo, Milano (MI) (IT); Marco Penco, Genova (GE) (IT)

(21) Appl. No.: 16/308,552

(22) PCT Filed: Jun. 5, 2017
(86) PCT No.: PCT/EP2017/063623

§ 371 Date: Dec. 10, 2018

(30) Foreign Application Priority Data
Jun. 10, 2016 (IT) 102016000059919

(51) Int. Cl. A61G 7/08; A61G 7/05

(52) U.S. Cl. CPC A61G 7/08; A61G 2203/22; A61G 2203/726; A61G 7/05

(57) ABSTRACT

A device (10) for assisted omnidirectional movement of hospital beds (12) and other omnidirectionally mobile loads, comprising: an L-shaped base structure (40); a first motor-driven steering wheel (41) set along a first arm of said L-shaped base structure (40); a second motor-driven steering wheel (42) set along a second arm of said L-shaped base structure (40); a third wheel (43) set in the corner point of said L-shaped base structure (40); said base structure (40) comprises means (30, 35) for engagement to said hospital beds (12) and other omnidirectionally mobile loads; and control means (50) to cause rotation and orientation said first motor-driven steering wheel (41) and said second motor-driven steering wheel (42); where said hospital beds (12) and other mobile loads comprise wheels (14), and the weight of said hospital beds (12) and other mobile loads is sustained only by said wheels (14).

The present invention relates to a device for assisted omnidirectional movement of hospital beds and other omnidirectionally mobile loads. The term “omnidirectionally mobile loads” is here meant to designate mobile loads that are able to perform any movement of rototranslation in the resting plane if they are appropriately urged by external forces, in particular, as in the case of hospital beds or stretchers. Frequently, omnidirectionality is obtained by using swivel wheels as points for resting of the load.

There exist different types of devices used for moving hospital beds. Typically, these are devices that lift the bed at least partially, which complicates the structure thereof and increases its cost.

Such devices are, however, heavy, cumbersome and consume a lot of energy for lifting. They are not easy to manoeuvre and do not enable omnidirectional movements that are very useful in narrow spaces; moreover, use of engagement elements that are based upon lifting of the bed risk damaging the bed or bringing about wear thereof in a short time.

The aim of the present invention is to provide a device for assisted omnidirectional movement of hospital beds and other omnidirectionally mobile loads that will overcome the drawbacks of the prior art.

Another aim is to provide a device that will be manageable.

A further aim is to provide a device that can be manoeuvred easily also in narrow environments.

Another aim is to provide a device that will not be cumbersome.

Yet a further aim is to provide a device that will be particularly safe during movement.

According to the present invention, the above aims and others still are achieved by a device for assisted omnidirectional movement of hospital beds and other omnidirectionally mobile loads comprising: an L-shaped base structure; a first motor-driven steering wheel set along a first arm of said L-shaped base structure; a second motor-driven steering wheel set along a second arm of said L-shaped base structure; and a third wheel set in the corner point of said L-shaped base structure; said base structure comprises means for engagement to said hospital beds and other omnidirectionally mobile loads; and control means to cause rotation and orientation of said first and second motor-driven steering wheels; where said hospital beds and other mobile loads comprise wheels and the weight of said hospital beds and other mobile loads is sustained only by said wheels.

Further characteristics of the invention are described in the dependent claims.

The advantages of this solution over the solutions of the prior art are various.

The device has the capacity of holonomous movement, i.e., the capacity of controlling directly all the degrees of freedom that characterize its own position.

In the case of an object that moves in a plane, as substantially is the device according to the present invention possibly engaged to an omnidirectionally mobile load (a category that in particular comprises hospital beds), the above degrees of freedom are three: translation in two mutually orthogonal directions, and rotation. In the case of the device according to the present invention, the property of holonomy results in the capacity to perform any movement required by the operator, whether of translation, rotation, or a combination of the two. It is evident how this capacity is extremely useful in particularly narrow contexts, as many of those that may commonly present in a hospital, such as corridors, bedrooms, lifts, encumbered environments.

The fact that lifting of the bed from the ground during transport is not required enables a considerable simplification of the device and a considerable reduction of the power required thereby during normal operation, to the advantage of costs, autonomy, and overall dimensions. Finally, there is no risk of causing damage to the bed.

Equipping the device with sensors and algorithms coming from the sector of robotics enables the device not only to perceive the surrounding environment and construct a rich and detailed internal representation thereof, but also to use this representation for evaluating the presence and degree of possible risks of collision, warn the operator of such risks and possibly intervene directly on the motors (for example, by reducing the speed of advance) in the case where a situation of danger arises.

Consequently, the anti-collision system guarantees, during long-range displacements at sustained speed (in “advance” mode), a greater safety for the operator, the possible patient who is being transported, other persons, and the surrounding environment.

The L-shaped structure of the device enables a smaller encumbrance of the machine during use to be achieved, which constitutes an aspect of fundamental importance in hospital environments, where the movement of beds involves passing through doors of rooms, lifts, etc. Moreover, also during parking, the shape of the structure enables space saving in so far as a number of machines can be parked by being pushed into one another.

The dual driving mode affords excellent manoeuvrability in all operating conditions without any need for a driving interface that is difficult to use for non-skilled operators.

This dual driving mode is specifically focused on the two scenarios of use typical for displacement of beds in a hospital environment, i.e., long-range displacements at high speed (in “advance” mode), for example between a patients bedroom and premises in which specialised examinations are conducted, and short-range displacements, which require great manoeuvrability and precision (in “manoeuvre” mode), for example those involved in positioning the bed with respect to the walls of a lift or of a bedroom or for positioning the patient in the position suitable for connecting up diagnostic or clinical equipment.

The characteristics and advantages of the present invention will emerge clearly from the ensuing detailed description of a practical embodiment thereof, illustrated by way of non-limiting example in the attached drawings, in which:

FIG. 1 shows a device for assisted movement of hospital beds and other omnidirectionally mobile loads, according to the present invention;

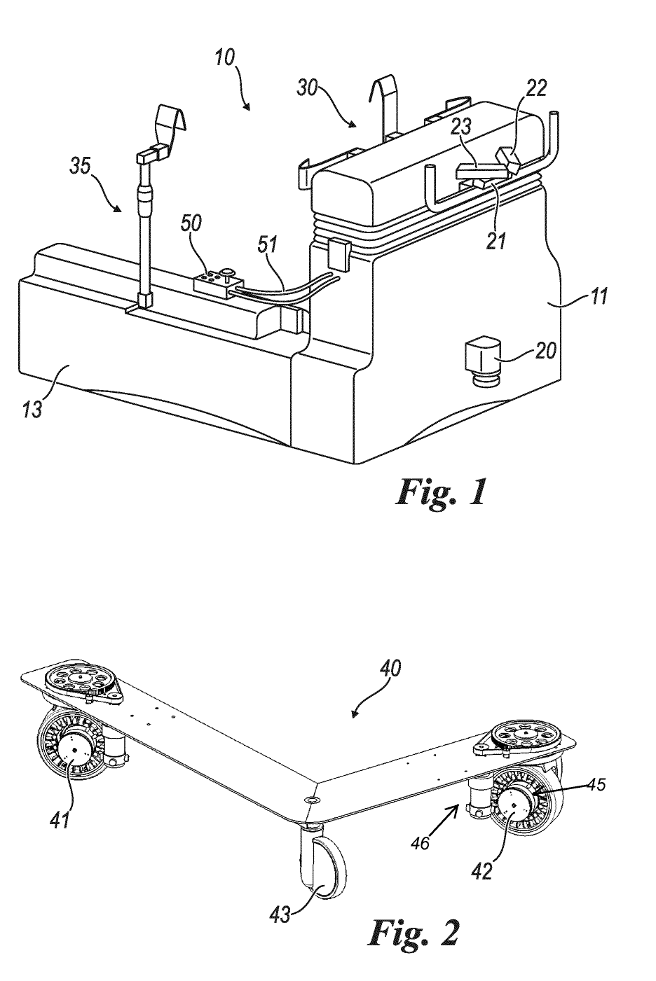

FIG. 2 shows the basic structure for movement of a device for assisted movement of hospital beds and other omnidirectionally mobile loads, according to the present invention;

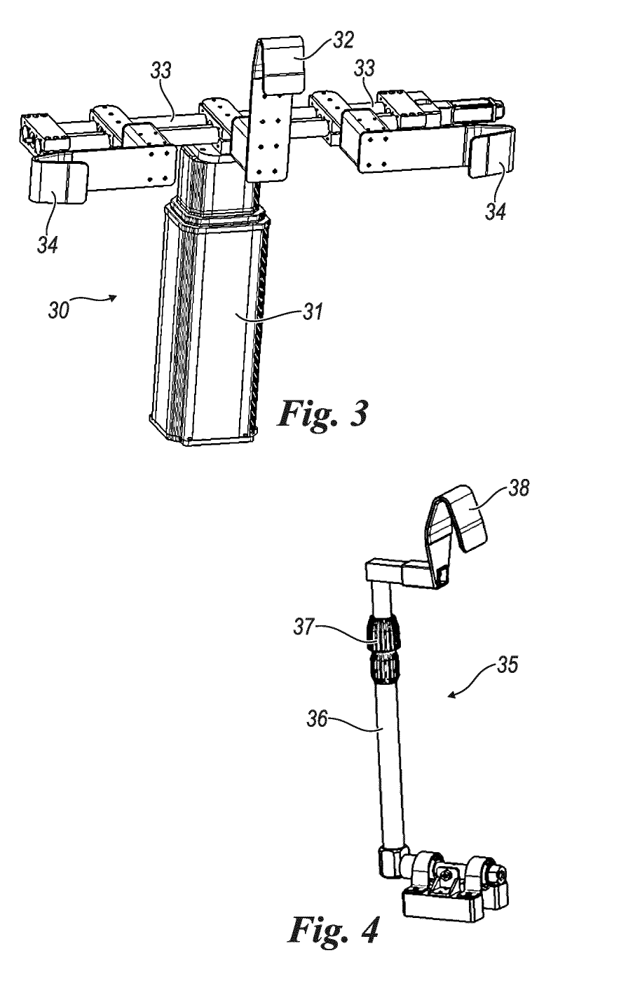

FIG. 3 shows a main assembly for engagement of a device for assisted movement of beds to a bed, according to the present invention;

FIG. 4 shows a secondary assembly for engagement of a device for assisted movement of beds to a bed, according to the present invention;

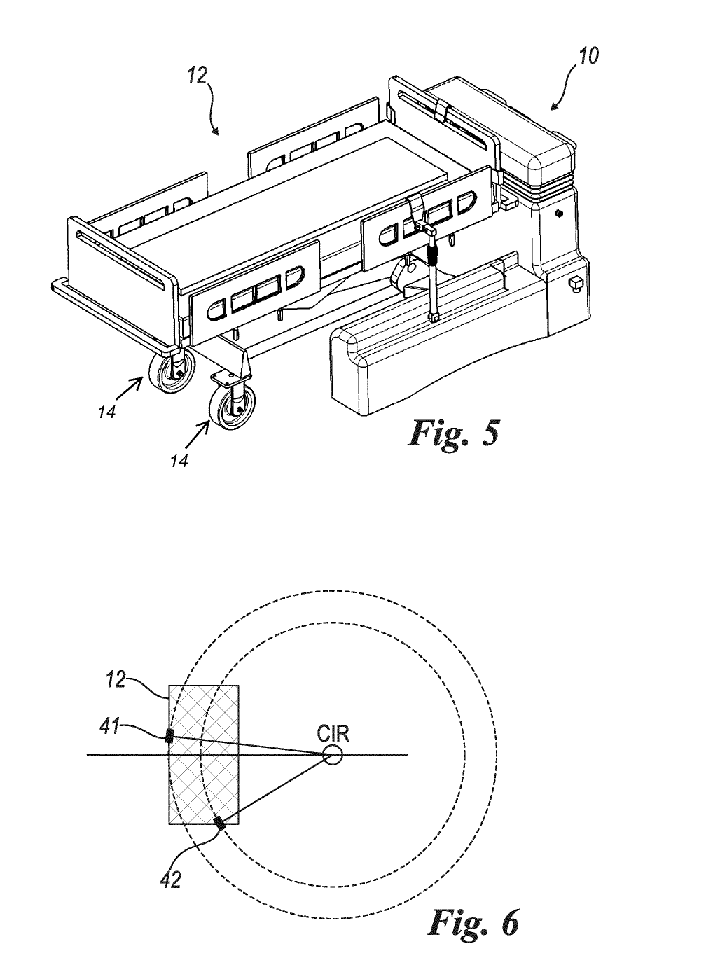

FIG. 5 shows a device for assisted movement of beds engaged to a bed, according to the present invention;

FIG. 6 shows motion of a device for assisted movement of beds, according to the present invention.

With reference to the attached figures, a device 10 for assisted movement of hospital beds and other omnidirectionally mobile loads, according to the present invention, comprises a front structure 11, which is almost as high as a bed 12, and a lateral structure 13 having a height lower than the bed 12. The bed 12 comprises four swivel wheels 14.

Located on the front structure 11 is a laser-scanner sensor 20 mounted in a front and central position, vertically lowered with respect to the frame so that the scanning plane comes to be parallel to the plane of movement of the vehicle itself and at a height of approximately 200 mm above it. This position is chosen so that this plane can intercept the legs of persons and other obstacles that may be present in front of the vehicle, such as children, and animals of small size.

Located on the front structure 11 are also preferably three 3D cameras, a front central one 21, and two side ones 22, 23. The 3D cameras 21-22-23 are designed to cover the central front area, the left-hand front area, and the right-hand front area of the operating space in front of the device. The three 3D cameras are positioned at a height from the ground that enables framing also of objects that might not rest on the floor such as fire extinguishers or cupboards which are frequently present in the hospital environment, in addition to framing the floor itself for detecting any possible depressions or reliefs, corresponding for example descending flights of stairs, cable ducts, supports for diagnostic equipment, etc.

The data produced by the 3D cameras, unlike the data produced by normal cameras, are constituted by three-dimensional clouds of points, accompanied, if need be, also by the image data that would be generated by ordinary cameras. These data may be generated via the various technologies afforded by commercially available 3D cameras, such as systems based upon passive optical triangulation at one and the same time (stereoscopy), active optical triangulation at one and the same time (pattern projection), passive optical triangulation at different times (visual odometry), time of flight. In the practical embodiment, 3D cameras with active optical triangulation at one and the same time are currently used.

The laser-scanner sensor generates data that are located in the plane in which the sensor carries out its scanning. The position and orientation of each 3D camera with respect to the laser sensor is determined in a preliminary step when the device for assisted movement is set in operation. Knowledge of the position and orientation of each 3D camera makes it possible to record the data of all the sensors in one and the same reference system. These data are stored and processed during operation of the system to prevent collisions in order to determine a local map only of the obstacles detected by the 3D cameras and by the laser sensor.

On this map, an evaluation is carried out to check whether the current action of motion can be performed and, in the case where a possible future collision were to be detected, the distance between the current position of the device and the position in which a collision is predicted is determined. This distance is used to modulate the commands of movement of the device so as to avoid collisions and high stresses for the patient being carried, within the obvious limits imposed by physics.

The first step for identification of a potential collision is the calculation of the footprint of the system constituted by the device and the bed. In particular, said footprint will be computed by discretising the occupation of the system constituted by the device and the bed within a grid with cells of predefined size.

Starting from the tangential and angular velocities at input, on the grid referred to above, the future path that the device will follow is computed assuming a constant motion. To determine the extent of the future path the minimum braking distance is considered, which is calculated as a function of the velocity at input and of the maximum deceleration of the system taking into consideration also a safety margin around the device, so as to evaluate whether, at the speed envisaged, there will be any collision with obstacles.

Finally, in the presence of a possible collision, the control system of the device implements actions aimed at avoiding collision; in particular, the tangential velocity or the angular velocity is modified (reduced) or the radius of curvature of the path is modified.

In particular, in the presence of a possible collision, a gradual deceleration of the motion of the device is carried out thus reducing the dynamic stresses on the load.

Set behind the front structure 11 is the main engagement assembly 30, which comprises a arm 31 preferably telescopic that terminates at the top with a hook-like engagement element 32 for engagement of the side of the bed. The arm 31 is extended and is then shortened, thus causing the engagement element 32 to engage the head or foot of the bed.

The telescopic arm 31 further comprises, at its top, two lateral arms 33, which may also be extended and shortened for lateral engagement of the short side of the bed (head or feet) by means of two further lateral hook-like engagement elements 34.

The procedures of engagement of the bed by the main engagement assembly are carried out thanks to the action of electric actuators. These are used both for vertical translation of the entire assembly (in order to adapt the position thereof to the specific object to be gripped) and for fixing it in position.

Each hook is provided with an inner rubber coating, necessary for enabling an even distribution of the interface loads between the engagement elements and the bed so as not to damage the surface of the anchorage parts of the bed. The system can adapt to heads and feet of beds of different size thanks to its flexibility of movement in a vertical and horizontal direction.

An alternative embodiment of the main assembly for anchorage to the bed or to the load envisages the possibility of gripping, via compression, the corner rollers of the bed or of the load where these are present.

To enable a greater effectiveness in performing rotations, reducing the intensity of exchange of forces and torques on the main engagement assembly 30 there is also envisaged a lateral engagement system 35, which grips the supporting lateral handle, i.e., the side of the bed.

The lateral engagement system 35 is an auxiliary system and enables adaptation to sides of beds of different type and sizes. It comprises a telescopic vertical support 36, which can be adjusted by means of ring nuts 37, and terminates at the top with a hook-shaped engagement element 38.

An alternative embodiment of said lateral engagement system envisages a vertical support of reduced length and an engagement to the lower part of the bed (for example, to elements of the frame).

In a further alternative embodiment of the engagement system, the lateral engagement system 35 is absent, and the hook-like engagement 32 is also absent. In this case, the main engagement assembly 30 consists only of the two lateral arms 33, which can be extended and shortened for lateral engagement of the head of the bed by means of the lateral hook-like engagement elements 34. The device 10 comprises a base structure 40, having an L-shaped structure, having two arms set at 90° with respect to one another, rising on which are the front structure 11 (on the short arm of the base structure 40) and the lateral structure 13 (on the long arm of the base structure 40). Two motor-driven steering wheels 41 and 42 are set at the two ends of the arms of the structure 40, and a third, idle, swivel wheel 43 is set in the corner point of the arms of the base structure 40.

Each of the motor-driven steering wheels 41 and 42 comprises a motor 45 for driving (i.e., causing rotation) of the wheel and a motor 46 for orienting the wheel, which are independent of one another.

Consequently, the term “motor-driven wheels” is meant to designate motor-driven wheels that can be activated upon command and by the term “steering” it is meant that they can be oriented in any direction upon command. The motor-driven steering wheels 41 and 42 are preferably set at the two ends of the structure 40, but there is nothing to rule out the possibility of them being set in any position along each arm of the structure 40, according to the requirements. Moreover also the L shape is not binding: the device must have at least three points of rest on the ground, for its own stability.

The third, idle, swivel wheel 43 may be replaced by other passive devices capable of performing an omnidirectional motion, such as balls, low-friction sliders, etc. or else by another motor-driven steering wheel in the case where the traction required of the device were to exceed the traction that can be delivered by just two motor-driven wheels, for example to get over stretches with steep slopes.

To increase the traction that can be exerted by the device it is also possible to increase the power of the two motor-driven wheels, or alternatively, for example to avoid a greater encumbrance, further motor-driven steering wheels may be used.

Hence, the device is normally equipped with two motor-driven steering wheels and one passive wheel, whereas a hospital bed is generally equipped with four passive swivel wheels.

The configuration adopted with two driving steering wheels, set along the two arms of the frame, and an idle wheel located at the intersection of said arms bestows on the device the possibility of performing a holonomous movement. This configuration guarantees a good dynamic stability of the device, but requires an adequate control system during its motion, since it is necessary to co-ordinate the action of the motor-driven wheels appropriately.

In particular, the base structure 40 consists of just one L-shaped structure, and has only three wheels 41, 42, and 43, to minimise encumbrance thereof, facilitate the operations of engagement and release to/from the bed, and reduce to a minimum the space occupied by the machine during parking, and has a typical size of 100×150 cm. The present invention, in addition to the front structure, exploits the space available laterally beneath the plane of the bed to develop the structure longitudinally and obtain a point of engagement and lateral traction that enables the traction required for omnidirectional movements with an arm of the force that is much more favourable.

Engagement of the device 10 to the load is obtained by setting the device alongside the bed, without lifting the latter, and actuating the electric actuators of the main engagement assembly 30 and of the lateral engagement system 35.

The load, i.e., the bed 12, is engaged and not lifted; hence, the weight of the bed 12 is supported only by its wheels 14, and the device 10 moves the bed 12 only by pushing it or pulling it.

The L-shaped base structure 40 slides underneath the bed, without touching it, and the front structure 11 engages only to the head of the bed, and possibly the lateral structure 13 engages to the side of the bed.

Housed in the bottom part of the frame of the device 10 are rechargeable batteries for supply of the device. The weight of the batteries is exploited to maximise the forces of contact between the motor-driven wheels and the resting plane, in order to maximise the friction associated and hence maximise also the values of the tangential forces that the motor-driven wheels are capable of exchanging with the plane in the absence of sliding. The above result is obtained by positioning the batteries in the vicinity of the motor-driven wheels, compatibly with the dimensions of the other members.

As regards transmission of the commands from the operator to the device, this is obtained via a remote control 50. The remote control 50 is connected to the device 10 by a connection cable 51, appropriately strengthened to render it able to resist tensile forces, torsion, shear, and squeezing. In particular, the remote control can be connected to the device by means of a magnetic coupling, which, in the case of release of the connector, stops the device.

The remote control 50 includes a joystick and pushbuttons.

The joystick is used for imparting on the device the main commands regarding movement.

The pushbuttons include the buttons via which the operator imposes the desired operating mode on the device. Among the functions governed by the pushbuttons, the most important are: the choice of the active driving mode between the two available ones (“advance” or else “manoeuvre”, described in what follows); turning round on the spot in “manoeuvre” mode; activation/deactivation of the safety brake of the device; the operating status of the system for detecting obstacles; activation of the acoustic alarm (horn).

The device transmits notifications to the operator. The notifications of interest are transmitted to the operator in acoustic mode, visual mode, and/or tactile mode (vibration).

The acoustic-warning mode is mainly used for transmission of information regarding events, i.e., temporary conditions such as a risk of collision. A similar use is envisaged for the tactile-warning mode.

The visual mode is based upon an appropriate LED display, positioned so as to be readily visible to the operator. It is mainly used for communication of states, i.e., conditions that persist in time, such as: the active driving mode (“advance” mode or else “manoeuvre” mode); the fact that the safety brake of the device is or is not activated; the operating status of the system for detecting obstacles (active or inactive); and the level of charge of the batteries of the device.

Driving of the device is carried out by the operator via the remote control.

The device has available two driving modes, between which the operator can select the one most suited to the particular current operating condition.

In the “advance” mode the vehicle is driven in a way similar to a motor vehicle (Ackermann kinematics), albeit presenting additional capabilities as compared to said vehicles such as the capacity of turning round on the spot.

In the “manoeuvre” mode, which is carries out at low speed, the vehicle is able to translate parallel to itself in any direction (for example, in order so be brought up against a wall or set in a corner) or else to turn round on the spot about a predefined vertical axis, for example, the axis passing through the centre of the rectangle defined by the four resting points of the hospital bed carried, in what follows referred to as “geometrical centre” (CGC) of the ensemble constituted by the bed and the device.

In the “advance” mode, the operator has available two commands: a command that regulates the speed of advance/reverse (conceptually similar to the accelerator of a car), and a command (conceptually similar to the steering of a car) for regulating the instantaneous steering radius (distance between CGC and CIR, which is the centre of instantaneous rotation).

Said commands are imparted by exploiting the remote control. More precisely advance/reverse is imparted by the operator by inclining in the forward/backward direction the joystick, whereas, by inclining the joystick in the right/left direction, the operator imparts the radius of curvature of the path followed by the ensemble constituted by the device and the load possibly carried thereby. In the “advance” mode the forward/backward position of the joystick imposes the modulus and direction of the instantaneous-velocity vector of the ensemble. Said velocity corresponds to the one at which the ensemble travels, in the resting plane, along a circumference centred on the CIR.

In the “advance” mode, the left/right position of the joystick sets the distance of the CIR from the CGC, hence varying the radius of curvature of the path of the rigid body constituted by the ensemble.

When the lever is not inclined either to the right or to the left, the CIR is set at infinity, and the bed moves forwards or backwards along a straight line passing through the geometrical centre of the ensemble and directed along the sagittal axis of the structure.

The more the lever is inclined towards one of the lateral end-of-travel positions, the more the CIR moves towards the centre of the bed, to the right-hand side in the case where the lever is inclined to the right, and to the left-hand side in the opposite case. The minimum distance of the CIR from the geometrical centre of the device is a configurable parameter of the control system of the device.

In the “manoeuvre” driving mode, the joystick is used in a different way from that of the “advance” mode. Precisely, by inclining the joystick in a given direction with respect to the reference system of the joystick (identified by the forward/backward and right/left axes) the operator imposes on the rigid body formed by the ensemble constituted by the device and the load carried a motion, in the resting plane, of pure translation parallel to the rigid body itself. The direction and sense of said motion correspond to the inclination of the joystick, however, in a reference system having its origin in the geometrical centre of the device (already defined previously) and axes parallel, respectively, to the shorter arm and to the longer arm of the L-shaped branch of the device. During execution of this motion of pure translation, the inclination of the joystick with respect to the central resting position defines the modulus of the instantaneous velocity with which the ensemble constituted by the device and the load moves according to the direction and the sense defined above.

As an alternative to the movements of pure translation, in the “manoeuvre” mode the device is able to perform also movements of pure rotation about the vertical axis passing through the CGC. These movements are activated by two purposely provided buttons of the remote control, dedicated one to rotation in a counterclockwise direction and the other to rotation in a clockwise direction. The angular velocity of said motions of rotation can be fixed and predefined, or else increase in time following a law that can be configured within the control system of the device.

In an alternative embodiment of the device, rotation in the “manoeuvre” mode is not governed by specific buttons, but rather by the joystick. In this embodiment, switching of the joystick from the command for the motion of translation to the command for the motion of rotation may be performed by operating a further control (for example a push-button).

In a further alternative embodiment of the device, the joystick may be replaced by a so-called “triaxial joystick”, i.e., a joystick in which also rotation of the lever about its own axis is possible. In this embodiment, rotation of the lever of the joystick controls the distance of the CIR from the geometrical centre of the device in the “advance” driving mode, and controls the angular velocity of rotation about the geometrical centre of the device in the “manoeuvre” mode.

In all the embodiments, in both of the driving modes (“advance” and “manoeuvre”) the motion required of the device by the operator via the remote control is obtained via an appropriate manoeuvre of the motor-driven steering wheels with which the device is equipped. In particular, the control system of the device receives at input the commands desired by the user via the remote control. In a first step, the data are analysed and corrected in the case of any inconsistency between the current operating mode and the command. Next, using the geometrical parameters of the structure of the device and an estimate of the geometrical quantities of the load to be moved, the desired configurations of steering of the motor-driven wheels and the corresponding velocities are calculated. These parameters enable configuration of positioning of the geometrical centre of the ensemble both with respect to the sagittal axis of the system and with respect to the orthogonal axis, which has a direct effect on the motion of the ensemble. The advantage of this solution lies in the configurability of the motion with respect to the geometrical characteristics of the load transported by the movement system.

The orientation of the motor-driven wheels is controlled by the low-level devices provided in such a way that the distance of the CIR will be the one desired by the user. These devices are constituted by the drivers for asynchronous motors interfaced via CANBus, which are able to drive the actuators (for steering and traction) receiving from them the feedbacks of position and velocity, i.e., steering angle and rolling velocity of the wheels, thus providing a closed-loop control system. The feedbacks are acquired by the sensors provided on the motors of the vehicle, i.e., two-channel encoders, induction sensors for reset of the corresponding encoders, temperature sensors, and voltage and current sensors. The drivers carry out a monitoring on the operation of the actuators interrupting their supply in the case of errors such as overcurrents or reference-tracking errors.

The rolling velocity of the motor-driven wheels defines, instead, the velocity with which the device and the load move along their own path (which, for geometrical reasons, may be represented instant by instant as a circumference centred on the CIR).

Also this is controlled by low-level devices that close a velocity-control loop on the sensors of the motor-driven wheel. The aforesaid control systems and electronic devices that govern the motor-driven wheels carry out a constant monitoring on their state to guarantee that they operate properly and that the desired configurations are implemented or issue a failure warning otherwise. The desired configurations are a translation, through the kinematic model of the vehicle, of the quantities desired by the user (translational and angular velocity for the entire structure) into reference values of steering and rolling velocity for each motor-driven wheel with which the system is equipped. The electronic devices, before carrying out setting of the rolling velocity of the individual motor-driven wheel, verify that the steering angle corresponds to the reference value calculated by the kinematic model of the vehicle but for a tolerance parameter that can be set by the manufacturer to guarantee that the motion of the vehicle will not be able to cause damage to the structure, will be consistent with what is required by the user and, at the time same, will enable movement of the vehicle according to the operating mode selected.

The low-level systems, moreover, scan the operating mode in which the system is working, guaranteeing that no manoeuvres that are not envisaged in the current mode can be performed, such as a movement of pure rotation on of the system on the spot when the device is operating in “advance” mode.

Implementation of low-level control laws hence enables of displacement of the movement system and the load according to the requirements of the user via just the interaction with the interface for acquisition of the commands.

The device comprises a cover with the aim of isolating the mechanical part and the electrical part from the external environment, in order to prevent any accidental contacts with operators and/or patients. The cover is made up of outer protective casings (at the sides and at the rear) assembled together and by bellows of elastomeric material, useful for hiding the movement parts and electrical elements and preventing any contact therewith.

The device comprises a processing and control platform of an embedded type, which has the purpose of: providing the system with the computation capacity necessary for performing and implementing the basic functions of the device; providing an efficient and effective communication service between the various (low level) subsystems that make up the device according to the invention; and providing a storage service for saving the significant information for subsequent system analyses.

The embedded platform is equipped with a wireless communication system capable of connecting up to an appropriately configured network device. The embedded platform and the network device share a configurable encryption key that enables encryption of the data that travel. Moreover, the particular configuration of the platform does not enable direct connection to the vehicle, but it is the latter that, by recognising the parameters of the wireless network transmitted by the network apparatus, connects up enabling access to the processing platform on board following upon a process of authentication of the credentials. Communication with the vehicle enables configuration both of the operating parameters (for example, the geometrical dimensions of the system) and of the user parameters (for example, the sensitivity of the joystick), as well as the possibility of viewing and recovering the files stored that contain the information on the state of the system during its use and historic data on the commands supplied thereto, including possible anomalous events that have occurred during use.

The device thus conceived may undergo of numerous modifications and variations, all of which fall within the scope of the inventive idea; moreover, all the items may be replaced by technically equivalent elements.

1.-10. (canceled)

11. A device (10) for assisted omnidirectional movement of hospital beds (12) and other omnidirectionally mobile loads comprising:
an L-shaped base structure (40);
a first motor-driven steering wheel (41) set along a first arm of said L-shaped base structure (40);
a second motor-driven steering wheel (42) set along a second arm of said L-shaped base structure (40);
said first (41) and second (42) steering wheel comprise a motor (45) for driving the wheel and a motor 46 for orienting the wheel, which are independent of one another;
a third wheel (43) set in the corner point of said L-shaped base structure (40);
said base structure (40) comprises means for engagement (30, 35) to said hospital beds (12) and other omnidirectionally mobile loads; and
control means (50) to cause rotation and orientation of said first motor-driven steering wheel (41) and said second motor-driven steering wheel (42);
where said hospital beds (12) and other mobile loads comprise wheels (14) and the weight of said hospital beds (12) and other mobile loads is sustained only by said wheels (14);
a control system of the device receives at input the commands desired by the user via the remote control (50), the control system using the geometrical parameters of the structure of the device and an estimate of the geometrical quantities of the load to be moved to calculate the desired configurations of steering of said first (41) and second (42) motor-driven steering wheel and the corresponding velocities, the control system receiving from said first (41) and second (42) motor-driven steering wheel the feedbacks of position and velocity, thus providing a closed-loop control system.

12. The device according to claim 11, characterized in that said third wheel (43) is an idle swivel wheel.

13. The device according to claim 11, characterized in that said third wheel (43) is a motor-driven steering wheel.

14. The device according to claim 11, characterized in that said engagement means (30, 35) comprise a main engagement assembly (30), which includes a telescopic arm (31) and two lateral telescopic arms (33) terminating with two lateral hook-like engagement elements (34).

15. The device according to claim 11, characterized in that said engagement means (30, 35) comprise a lateral engagement system (35) that includes a telescopic vertical support (36) and terminates at the top with a hook-shaped engagement element (38).

16. The device according to claim 11, characterized in that said control means (50) comprise a joystick and push-buttons.

17. The device according to claim 11, characterized in that said control means (50) comprise means for passing from a first driving mode to a second driving mode of said device, in the first driving mode the operator having available a first control that regulates the speed of advance/reverse, and a second control that regulates the radius of steering, and in the second driving mode the operator having available a third control for rotation in a counterclockwise direction and a fourth control for rotation in a clockwise direction; and comprises commands for translation parallel to the sides of said device.

18. The device according to claim 11, characterized in that it comprises opto-electronic sensors (20, 21, 22, 23) capable of detecting the three-dimensional structure of the environment present in front of said device.

19. The device according to claim 18, characterized in that the three-dimensional structure of the environment present in front of said device is processed to evaluate the presence of possible collisions along the future path of the device.

20. The device according to claim 19, characterized in that, in the case of a possible future collision, it implements a gradual deceleration of the motion of said device.
